(19) United States
(12) Patent Application Publication
(10) Pub. No.: US 2025/0223972 A1
(43) Pub. Date: Jul. 10, 2025

(54) DRIVE RING FOR ROTARY SHAFT EQUIPMENT SEALS

(71) Applicant: John Crane Inc., Morton Grove, IL (US)

(72) Inventors: Brian Kalfrin, Pearland, TX (US); Mark Savage, Chicago, IL (US); Tom Mowbray, Rangeley, ME (US)

(21) Appl. No.: 19/010,915

(22) Filed: Jan. 6, 2025

Related U.S. Application Data
(60) Provisional application No. 63/617,932, filed on Jan. 5, 2024.

(51) Int. Cl. F04D 29/08; F04D 29/58; F16J 15/34

(52) U.S. Cl. CPC F04D 29/086; F04D 29/586; F16J 15/34

(57) ABSTRACT

A mechanical seal assembly configured to be coupled to a rotating shaft of a machine, includes: rotating and stationary rings configured so that rotating ring rotates with the shaft and relative to the stationary ring; and a rotating ring drive ring that includes features formed at least on an outer surface thereof, the rotating drive ring configured to hold the rotating ring in a fixed relationship relative the rotating shaft. The features can increase the rotation of fluid near the seal when in operation.

### CROSS REFERENCE TO RELATED APPLICATIONS

This application claims the benefit of an earlier filing date from U.S. Provisional Application Ser. No. 63/617,932 filed Jan. 5, 2024, the entire disclosure of which is incorporated herein by reference.

### TECHNICAL FIELD

This invention relates to rotary shaft equipment having mechanical seal assemblies providing a seal between a stationary housing and rotatable shaft of the rotary shaft equipment.—More particularly, it relates to such rotary shaft equipment that provide a drive ring to interact with a seal flush liquid used to cool a mechanical seal assembly.

### BACKGROUND

Mechanical seals are used to provide a seal between a rotating shaft and a stationary housing of a pump, compressor, turbine, or other rotating machine. End face mechanical seals generally include a primary seal interface comprising two relatively rotatable seal faces. Frictional wear between the seal faces can cause a gap to form therebetween, leading to excessive leakage. Accordingly, some end face seals require regular adjustment in order to maintain the appropriate or axial position of an axially shiftable seal member (also known as “seal height”) in order to account for such wear.

Various biasing mechanisms have been contemplated to provide a closing force to automatically accommodate wear. Such biasing mechanism have included single and multiple coil springs, and metal bellows.

Pusher seal assemblies comprise a dynamic secondary seal (such as an o-ring) to provide a seal between the shaft and the seal members themselves. The dynamic secondary seal of pusher seals is generally configured to move axially with the axially shiftable seal member. This axial movement relative to the shaft can cause fretting or shredding of the secondary seal due to friction.

Non-pusher seals generally feature a secondary shaft seal that is not intended to move axially relative to the shaft or an elastomeric bellows.

Regardless of the type of seal, the seal will often be provided a flush liquid to lubricate and cool the seal faces. The flush liquid can be taken from outlet of the rotary machine (e.g., pump) and provided back into the seal chamber at a pressure that causes it to be directed back into the chamber of the seal.

### SUMMARY

Embodiments of the present disclosure meet may result in increased circulation of the flush fluid that would enable to increase cooling between the flush liquid and the mechanical seal to increase cooling of the seal.

According to embodiments, a drive ring is disclosed. The drive ring can include complex features and may be formed, for example, by additive manufacturing. Examples of such features more fully described below and include a scrolled outer surface.

Alternatively, the ring could be separate ring that that is added around the drive ring with the features provided on thereon.

In one embodiment, a pump system is disclosed. The system claim include: a pump having a housing and a pump outlet and that is driven by a rotating shaft; and a mechanical seal assembly coupled to and surrounding the rotating shaft that seals a fluid in a chamber of the pump so that liquid in the chamber exits the pump via the pump outlet. The mechanical seal assembly can be disposed in the housing and include: rotating and stationary rings configured so that the rotating ring rotates with the shaft and relative to the stationary ring; and a drive ring that includes scrolled features on an outer diameter thereof that offset from a rotational axis of the drive ring by and angle α, wherein the drive ring configured to hold the rotating ring in a fixed relationship relative to the rotating shaft.

In the system of any prior embodiment, the features can be shaped as parallelograms.

In the system of any prior embodiment, adjacent features can be separated by a trough.

In the system of any prior embodiment, the features can extend beyond a front of the rotating ring drive ring

In the system of any prior embodiment, the system can also include a gland plate coupled to the housing such that it defines a cooling chamber between the housing and the rotating and stationary rings. The gland plate can include a flush inlet that is in fluid communication with the chamber.

Also disclosed is a mechanical seal assembly configured to be coupled to a rotating shaft of a machine. The seal assembly can include: rotating and stationary rings configured so that the rotating ring rotates with the shaft and relative to the stationary ring; and a drive ring that includes scrolled features on an outer diameter thereof that offset from a rotational axis of the drive ring by and angle α, wherein the drive ring configured to hold the rotating ring in a fixed relationship relative to the rotating shaft.

In the assembly of any prior embodiment, the features are shaped can be parallelograms.

In the assembly of any prior embodiment, adjacent features can be separated by a trough.

In the assembly of any prior embodiment, the features can extend beyond a front of the drive ring.

Also disclosed is a method of operating a mechanical seal assembly of any prior embodiment. The method can include: coupling the mechanical seal assembly to a rotating shaft that drives the pump, wherein the mechanical seal assembly is coupled to shaft so that it surrounds the shaft and seals a fluid in a chamber of the pump so that liquid in the chamber exits the pump via a pump outlet, the mechanical seal assembly including:

The method can also include coupling a gland plate coupled to a housing of the pump such that it defines a cooling chamber between the housing and the rotating and stationary rings.

The method can also include providing cooling fluid to the region near the seal assembly through a flush inlet in the gland plate.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1A is a cross-sectional view showing a rotating machine with a mechanical seal according to one embodiment;

FIG. 2 is an isometric view of a drive ring having scrolled features according to one embodiment;

FIGS. 3A and 3B show simulation results of fluid flow lines utilizing the ring of FIG. 2; and

FIG. 4 is an isometric view of a drive ring having scrolled features according to one embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Turning now to an overview of technologies that are more specifically relevant to aspects of this disclosure, a new manner of cooling rings or other elements of mechanical seals is provided. The cooling can be provided by providing features at a surface that moves with a rotating ring in the seal. For example, the features can be on a surface (e.g., outer diameter) of a rotating drive ring or on a separately formed pumping ring that surrounds the rotating drive ring. While the rotating ring is shown as a primary ring herein, the teachings could be applied to any rotating ring (e.g., a mating ring). Such features can lead to enhanced fluid movement around 360° of the sealing interface, yielding more efficient heat transfer while minimizing vapor pocket formation.

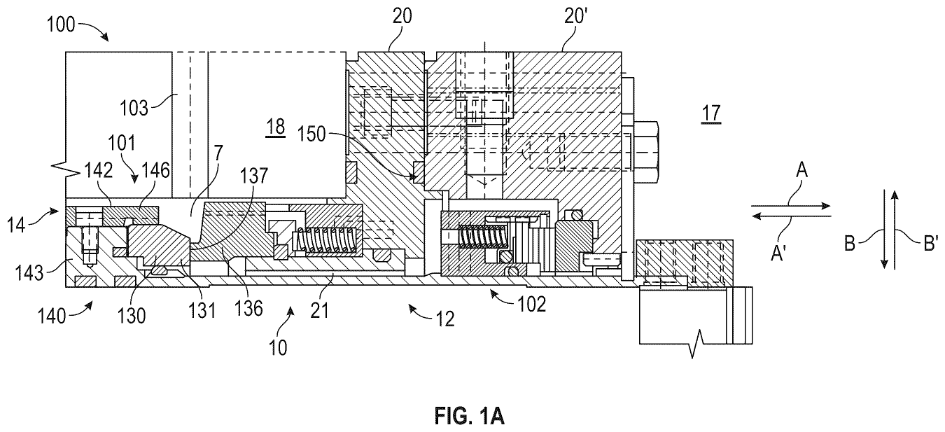

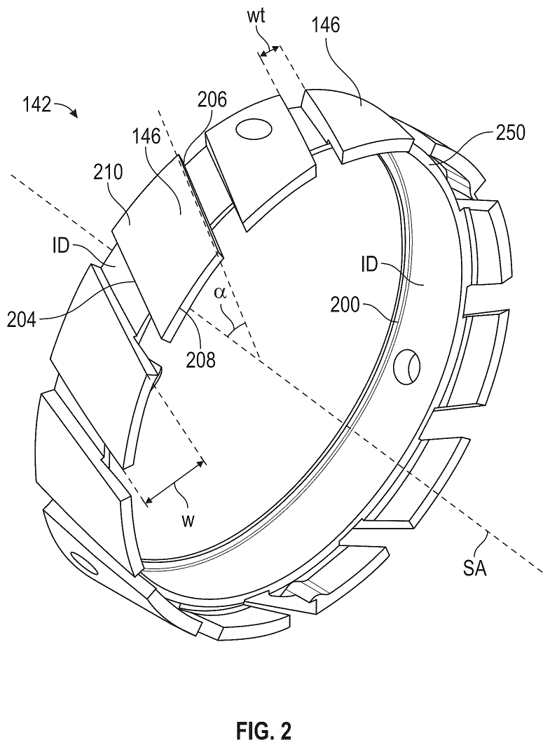

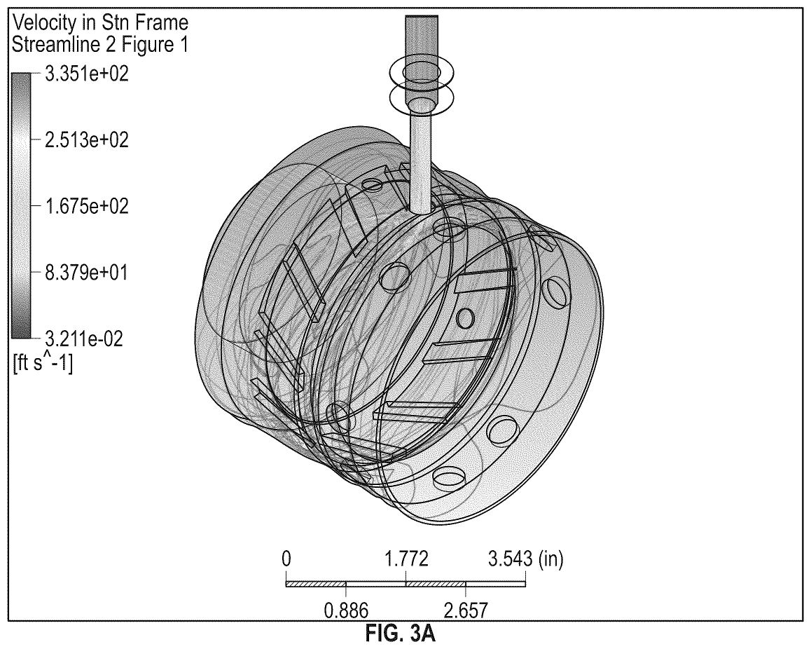

FIG. 1 is a cross-sectional view showing a rotating machine 100 such as a compressor or other pump having mechanical seal assembly 10 that seals a liquid in a chamber 14 of the machine 100. The following discussion will refer to a pump for convenience but that is not meant to limit the teachings to only a pump. FIG. 1 is described in general to both set forth components in embodiments discussed below and to describe the systems to which the embodiments herein may improve. Thus, any element described with relation to FIG. 1 can also form part of any embodiment disclosed herein.

The seal assembly 10 is arranged such that it surrounds the rotating shaft 12 and acts on a liquid (e.g., a hydrocarbon) in the chamber 14 so that it does not escape and possibly enter the atmosphere 17. As shown, the seal assembly 10 includes two seals, a first seal 101 and a second seal 102. The teachings here in can be applied to either or both of the first or second seals 101, 102 as well as the case where only a singular inboard seal is used.

The liquid in the chamber 14 of the machine 100 may aid in cooling the first seal 101. The liquid is provided into a cooling fluid chamber 7 via a fluid/flush inlet 103 and then returns back into the chamber 14 in normal operation.

The seal assembly 10 can be arranged coaxial of the shaft 12 in a bore defined by an annular housing 18 coaxial of shaft 12. Various stationary (or non-rotating) components of seal assembly 10 can be operably coupled to housing 18, or one or more gland plates 20, 20′, which is in turn also operably coupled to housing 18. The seal assembly 10 ensures that the primary path that liquid can exit the chamber 14 is via the pump outlet and so that little to no fluid can exit the chamber 14 via a space 21 between the shaft 12 and the housing 18.

From time to time certain directions will be used herein. An outboard direction is the direction extending in the direction of arrow A and the inboard direction (e.g., towards the chamber 14 described below) is in the opposite direction as indicated by arrow A′. The radially inward direction is in the direction of arrow B which is directed toward a center of the shaft 12 and the radially outward direction is in the opposite direction as indicated by arrow B′. Further, the fluid that has not yet entered the pump (or before it is expelled therefrom) may be referred to as “upstream” of the pump and fluid that has left the pump is “downstream” of the pump 100.

Fluid in chamber 14 is pumped through the machine 100 due to rotation of the shaft 12. In more detail, the shaft 12 will turn elements such as impeller attached thereto and create an operational pressure in the chamber 14.

In the illustrated embodiment of FIG. 1, the seal assembly 10 (and in particular, seal 101) is arranged such the housing 18 defines the cooling fluid chamber 7 on the outer diameter of the seal 101. As shown the cooling liquid is provided to the cooling fluid chamber 7 from the chamber 14 via inlet 110 in the housing 18. The cooling fluid can then interact with the seals 101, cool the, and then leave return to the chamber 14. Cooling fluid that passes through the first seal 101 can be kept in the machine by the second seal 102.

It has been discovered that at times that cooling of the seal 101 can be less that optimal in certain space constrained situations (e.g., when there is only one inlet and/or the cooling fluid chamber 7 is small relative to seal 101. This can be due to the fact that the circulation flow rate induced by the prior art is insufficient. Embodiments herein improve the cooling in the cooling fluid chamber 7 by distributing cooling flow rates through improved designs for a drive ring that is part of the seal 101 and in particular, surrounds the rotating ring 130 discussed further below.

In the following discussion an example seal 101 is described. This illustrated seal 102 is an elastomer o-ring seal but it shall be understood that the teachings herein can be applied to any type of rotating seal that includes two rings.

The illustrated seal 102 includes two rings 130, 136 having opposing faces 131, 137 that rotate relative to one another in operation. The rings 130, 136 may be referred to, respectively, as rotating and stationary rings herein. The stationary ring 136 can be fixedly attached to the annular housing 18 or to a gland plate 20 as illustrated. The rotating ring 130 is connected to the shaft 12 by an assembly 140.

The assembly 140 as illustrated includes a drive or carrier ring 142 and a sleeve member 143 that is fixedly attached to the shaft 12. The drive ring 142 can be fixedly attached to the sleeve member 143 and can encase some or all of the rotating ring 130.

In general, during operation a liquid film develops between the faces 131, 137 as the faces rotate relative to one another. The rotation is caused by rotation of the shaft 12.

In this example, a first seal biasing mechanism 150 attached to the stationary ring 136 urges the rings 130, 136 of the seal together. In particular, the first seal biasing mechanism 150 biases the stationary ring 136 towards the rotating ring 130.

The liquid received from flush inlet 103 is generally held at the OD of the seal 101 where the faces 131/137 meet. Of course, some of the liquid will pass through the seal 101 and is deal with by the second seal 102.

The drive ring 142 includes scroll features elements 146 on an OD thereof.

As noted above, FIG. 1 shows the case where there were two seals are utilized. In an alternative embodiment, only one seal may be used.

FIG. 2 shows an example of a drive ring 142 according to one embodiment. The drive ring 142 includes scroll features 146 formed on an outer diameter thereof. The ring 142 includes a ring portion 200 that includes an inner diameter ID and an outer diameter OD.

As will be understood, the ring 142 will surround the rotating ring 130 (FIG. 1) and may help cool that ring and the seal 102 in general by increasing the amount of time the fluid remains in the cooling fluid chamber 7.

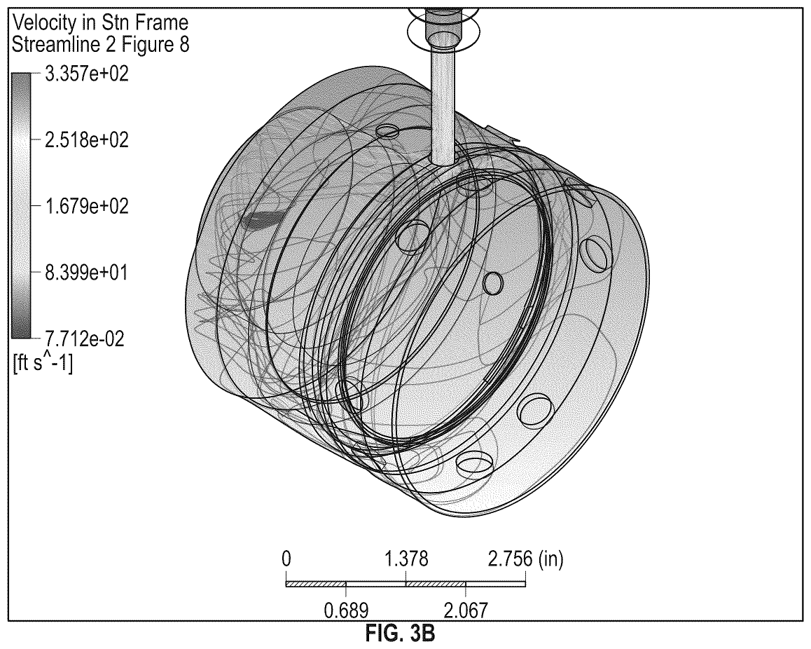

With reference to FIGS. 3A and 3B, simulations have shown that the velocity streamlines for a fluid introduced via flush inlet 103 are more circular in nature when the scroll features are present (FIG. 3A) than when they are not (FIG. 3B). This will increase the dwell time in the cooling fluid chamber and, thus, improve cooling of the seal 101.

Each scroll features 146 may include two sides 204, 208 a front edge 208 and a back edge 210. As shown, the scroll features 146 have a parallelogram shape with the sides being parallel to one another and the front and back edges 208, 210. Of course, other shapes could be employed. For example, the scroll features 146 could be ovoid's, diamond or shapes.

A trough 206 is formed between adjacent features 146 on the ring 142. The trough can be formed by removing metal from the drive ring to define it or by a process of adding the scroll features 146. The trough can vary in thickness but is typically less than one half the thickness of the ring. The troughs 206 can a width (wt).

The scroll features 146 can have a width (w). This width can be varied based on the number of scroll features 146 desired. The number may be determined based on the amount of circular motion needed. That is, the width w can varied based on the desired number of troughs 206/scroll elements 146 needed to cool. This can be determined either by experimentation or simulation or a combination thereof. As shown, the ring 142 has 12 troughs 206 and 12 scroll elements 146. In this case, if more cooling is needed, the width of the toughs wt could be increased and the width of the scroll elements 146 decreased. Similarly, if less cooling is needed, the width of the toughs wt could be decreased and the width of the scroll elements 146 increased. Or course, the number of each could also be changed.

The scroll features 146 (and also the troughs) may be offset at an angle α with respect to the axis of rotation (SA) of the scroll ring 142. This axis in operation will align with the axis of rotation of the shaft 12 (FIG. 1).

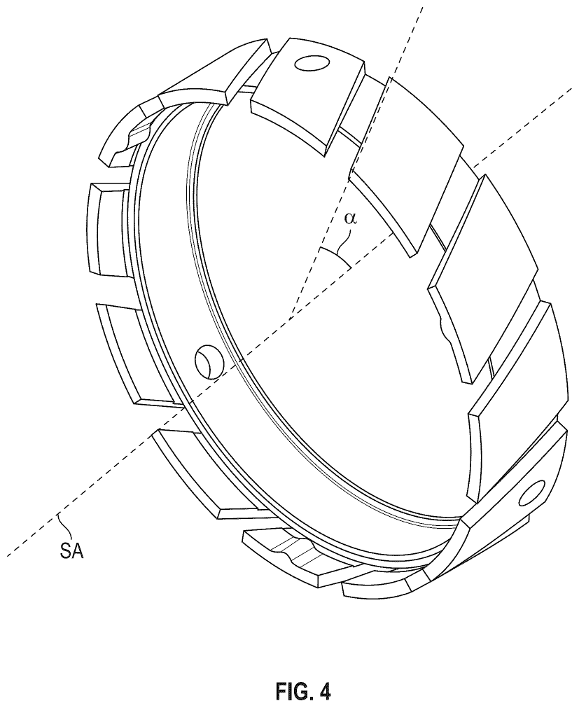

As shown, the scroll features 146 are arranged in a so-called right hand thread configuration and would be used for counterclockwise rotation shafts. The scroll features could also be arranged in a left hand thread configuration and would be used for clockwise rotation shafts. An example of ring having that configuration is shown in FIG. 4.

The combination of the trough 206 angled between 15 and 45 degrees has been shown through simulation to provide higher rotation of the fluid and, thus, better interaction with the ring 142. This will lead to better cooling of at least the rotating ring and possibly the entire seal. As with all embodiments herein, the features can be formed in many manners but one example is to form them via additive manufacturing. In such a case, the whole ring 142 (or any other ring disclosed herein) can be additively formed. This can reduce metal removal waste that was present in the prior art. This may also result in part consolidation and reduce required inventory requirements.

In both FIGS. 2 and 4 the features 246 extend beyond a front 250 of the rotating ring drive ring. Of course, this is not required.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A pump system comprising:
a pump having a housing and a pump outlet and that is driven by a rotating shaft; and
a mechanical seal assembly coupled to and surrounding the rotating shaft that seals a fluid in a chamber of the pump so that liquid in the chamber exits the pump via the pump outlet, the mechanical seal assembly being disposed in the housing and including:
rotating and stationary rings configured so that the rotating ring rotates with the shaft and relative to the stationary ring; and
a drive ring that includes scrolled features on an outer diameter thereof that offset from a rotational axis of the drive ring by and angle α, wherein the drive ring configured to hold the rotating ring in a fixed relationship relative to the rotating shaft.

2. The pump system of claim 1, wherein the features are shaped as parallelograms.

3. The pump system of claim 2, wherein adjacent features are separated by a trough.

4. The pump system of claim 1, wherein the features extend beyond a front of the rotating ring drive ring.

5. The pump system of claim 1, further comprising:
a gland plate coupled to the housing such that it defines a cooling chamber between the housing and the rotating and stationary rings, the gland plate including a flush inlet that is in fluid communication with the chamber.

6. A mechanical seal assembly configured to be coupled to a rotating shaft of a machine, the seal assembly comprising:
rotating and stationary rings configured so that the rotating ring rotates with the shaft and relative to the stationary ring; and
a drive ring that includes scrolled features on an outer diameter thereof that offset from a rotational axis of the drive ring by and angle α, wherein the drive ring configured to hold the rotating ring in a fixed relationship relative to the rotating shaft.

7. The seal assembly of claim 6, wherein the features are shaped as parallelograms.

8. The seal assembly of claim 6, wherein adjacent features are separated by a trough.

9. The seal assembly of claim 7, wherein the features extend beyond a front of the drive ring.

10. A method of operating pump including a mechanical seal assembly, the method comprising:
coupling the mechanical seal assembly to a rotating shaft that drives the pump, wherein the mechanical seal assembly is coupled to shaft so that it surrounds the shaft and seals a fluid in a chamber of the pump so that liquid in the chamber exits the pump via a pump outlet, the mechanical seal assembly including:
rotating and stationary rings configured so that the rotating ring rotates with the shaft and relative to the stationary ring; and
a drive ring that includes scrolled features on an outer diameter thereof that offset from a rotational axis of the drive ring by and angle α, wherein the drive ring configured to hold the rotating ring in a fixed relationship relative to the rotating shaft;
rotating the shaft to cause cooling fluid in a region near the mechanical seal assembly to rotate around the drive ring due to the scrolled features.

11. The method of claim 10, wherein the features are shaped as parallelograms.

12. The method of claim 10, wherein adjacent features are separated by a trough.

13. The method of claim 10, wherein the features extend beyond a front of the rotating ring drive ring.

14. The method of claim 10, further comprising:
coupling a gland plate to a housing of the pump such that it defines a cooling chamber between the housing and the rotating and stationary rings; and
providing cooling fluid to the region near the seal assembly through a flush inlet in the gland plate.
